(19) United States
(12) Patent Application Publication
(10) Pub. No.: US 2021/0332928 A1
(43) Pub. Date: Oct. 28, 2021

(54) PLUMBING ACCESS COVER

(71) Applicants: Randolph Charles STRANDLUND, Malahat (CA); Lori Anne STRANDLUND, Malahat (CA); Simon James BEAVIL, Victoria (CA)

(72) Inventors: Randolph Charles STRANDLUND, Malahat (CA); Lori Anne STRANDLUND, Malahat (CA); Simon James BEAVIL, Victoria (CA)

(21) Appl. No.: 17/235,274

(22) Filed: Apr. 20, 2021

Related U.S. Application Data
(60) Provisional application No. 63/015,114, filed on Apr. 24, 2020.

(51) Int. Cl. F16L 55/07

(52) U.S. Cl. CPC F16L 55/07

(57) ABSTRACT

A plumbing access cover includes a cap and an escutcheon. The cap has a cap body. The escutcheon has an annular flange and a retention collar for receiving the cap body. An engagement on the retention collar is provided for engaging the cap body, thereby releasably securing the cap body within the retention collar. The plumbing access cover is used to over a protruding plumbing cleanout.

### FIELD OF THE INVENTION

The present invention relates to the field of plumbing, more specifically drain cleanouts, shut-off valves and access to same.

### BACKGROUND OF THE INVENTION

In plumbing, a cleanout (sometimes clean-out) is a plumbing fitting with a removable element (usually a screw-on cap or screw-in plug), allowing access to a drain without the removal of plumbing fixtures. Cleanouts are installed to allow an auger (or plumber's snake) to be inserted to clean out a plugged drain. Since clean-out augers are limited in length, cleanouts should be placed in accessible locations at regular intervals throughout a drainage system (including outside the building). Minimum requirements are typically at the end of each branch in piping, adjacent each toilet, at the base of each vertical stack, and inside and outside the building in the main drain or sewer.

Drain pipes having cleanouts are often enclosed within walls comprising conventional wall cladding (e.g., drywall). Depending on the drain pipe size and positioning within the wall, the cleanout cap/plug may be recessed within the wall or may protrude from the wall, and the cleanout fitting may not be aligned with the wall (i.e., the cleanout opening may be slightly angled relative to the wall).

Often, in residential or commercial construction, access to a cleanout is via a rough hole cut in the drywall.

Utility access covers are known. For example, U.S. Pat. No. 6,520,713, Sondrup, Feb. 18, 2003, Height and angle adjustable utility access device and method; U.S. Pat. No. 6,524,026, Sondrup, Feb. 25, 2003, Adjustable height utility access device; and U.S. Pat. No. 6,799,920, Sondrup, Oct. 5, 2004, Angle adjustable utility access and method.

### SUMMARY OF THE INVENTION

There is provided a plumbing access cover which includes a cap and an escutcheon. The cap has a cap body. The escutcheon has an annular flange and a retention collar for receiving the cap body. An engagement on the retention collar is provided for engaging the cap body, thereby releasably securing the cap body within the retention collar.

The plumbing access cover, as described above is suitable for covering a plumbing clean out fitting. It is also suitable for covering other plumbing installations where access is required, such a a plumbing shut off valve.

While the plumbing access cover, as described above, will achieve the purpose of covering a plumbing cleanout fitting, for additional functionality, it is preferred that the engagement allows for different depths of insertion.

While the plumbing access cover, as described above, can work with different configurations of engagement, it is preferred that the engagement be a frictional engagement with the cap body.

While the plumbing access cover, as described above, can work with different configurations of frictional engagement, it is preferred that the engagement consist of a plurality of tabs with each tab having a distal portion resiliently biased inwards.

While the plumbing access cover can take on many different shapes, it is believed that having the cap body be cylindrical and the retention collar be cylindrical are the preferred shapes.

While the flange on the escutcheon of the plumbing access cover may simply rest against the wall, it is preferred that the flange on the escutcheon be affixed to a wall with caulking or an adhesive. In this regard, it is preferred that a peel and stick adhesive tape be position about a portion of the annular flange that in use abuts the wall.

### BRIEF DESCRIPTION OF THE DRAWINGS

These and others features will become apparent from the following description in which reference is made to the appended drawings, the drawings are for the purpose of illustration only and are not intended to be in anyway limiting, wherein:

FIG. 1, labelled as PRIOR ART, is a perspective view of a vertical drain behind a wall with a plumbing cleanout fitting.

FIG. 2, labelled as PRIOR ART, is a perspective close-up view of the plumbing cleanout fitting of FIG. 1.

FIG. 3 is a perspective view of a vertical drain behind a wall with a plumbing cleanout fitting and an embodiment of a plumbing access cover.

FIG. 4 is a front view of the vertical drain with the plumbing cleanout fitting and the embodiment of the plumbing access cover of FIG. 3.

FIG. 5 is a front close-up view of the plumbing access cover of FIG. 4.

FIG. 6 is an exploded perspective view of the plumbing access cover of FIG. 3.

FIG. 7 is an exploded close-up perspective view of the plumbing access cover of FIG. 6.

FIG. 8 is an exposed perspective view of the vertical drain with the plumbing cleanout fitting of FIG. 1.

FIG. 9 is the vertical drain, the plumbing cleanout fitting and the plumbing access cover of FIG. 4 with section lines A-A.

FIG. 10 is a section view of the vertical drain, the plumbing cleanout fitting and the plumbing access cover of FIG. 9 taken along section lines A-A.

FIG. 11 is a close-up section view of the vertical drain, the plumbing cleanout fitting and the plumbing access cover of FIG. 10.

FIG. 12 is a close-up section view of the interface between the wall and the plumbing access cover of FIG. 11.

FIG. 13 is a front view of the vertical drain, the plumbing cleanout fitting and the plumbing access cover of FIG. 8 showing a section line B-B.

FIG. 14 is n exploded section view of the vertical drain the plumbing cleanout fitting and the plumbing access cover taken along section line B-B of FIG. 13.

FIG. 15 is a close-up exploded section view of the plumbing cleanout fitting and the access cover of FIG. 14.

FIG. 16 is a chart showing the various approximate dimensions for the plumbing access cover of FIG. 15.

FIG. 17 is a bottom perspective view of a spacer ring.

FIG. 18 is a top perspective view of the spacer ring of FIG. 17.

FIG. 19 is a top perspective view of a flat cap variation.

FIG. 20 is a bottom perspective view of the flat cap variation of FIG. 19.

### DETAILED DESCRIPTION WITH REFERENCE TO THE DRAWINGS

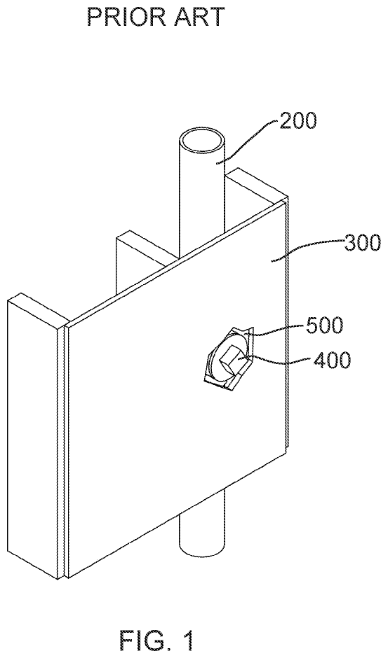

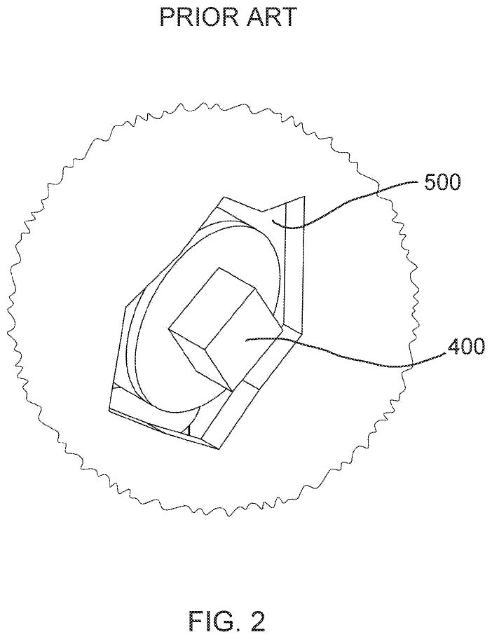

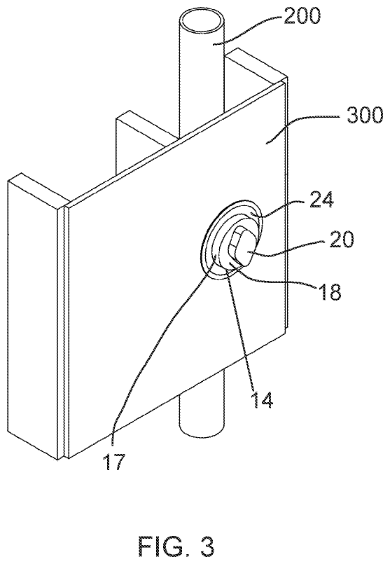

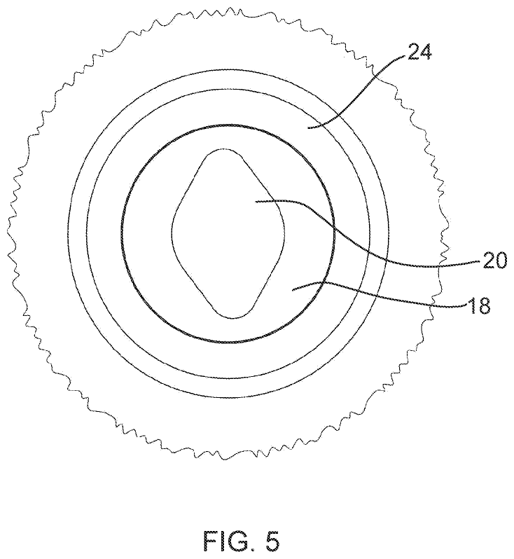

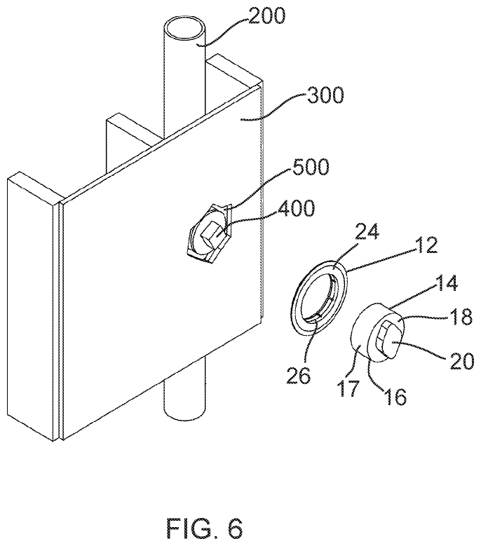

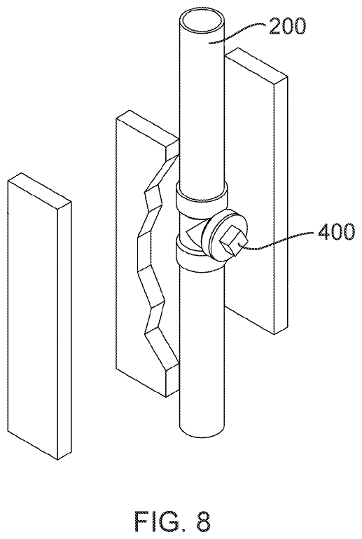

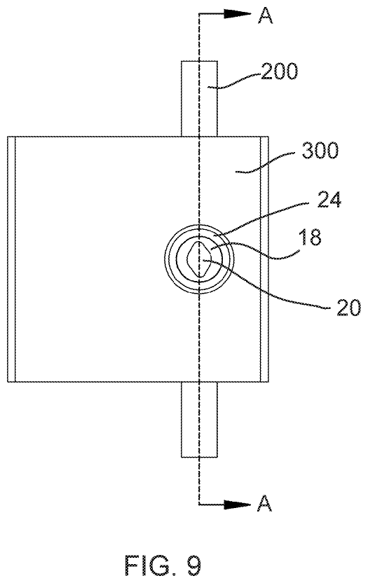

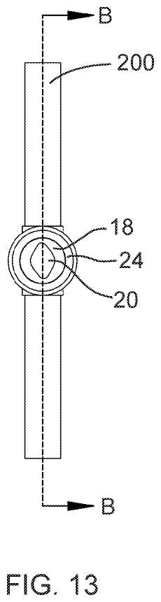

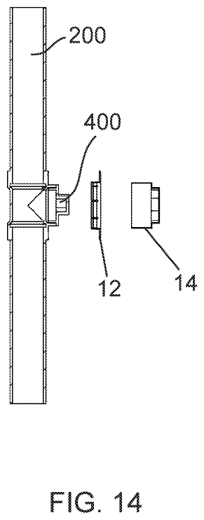

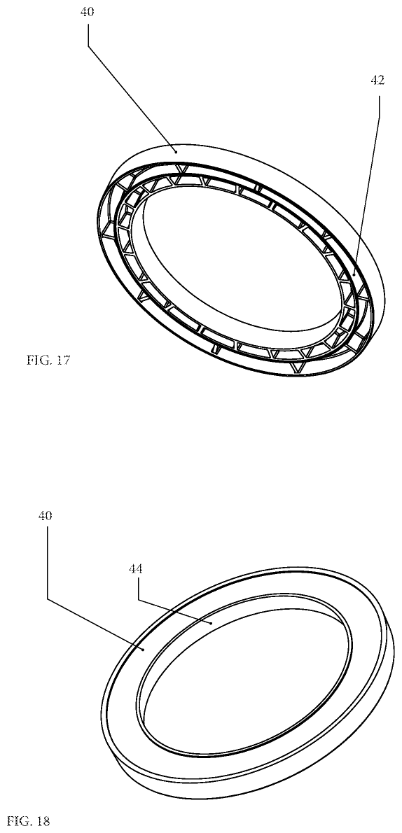

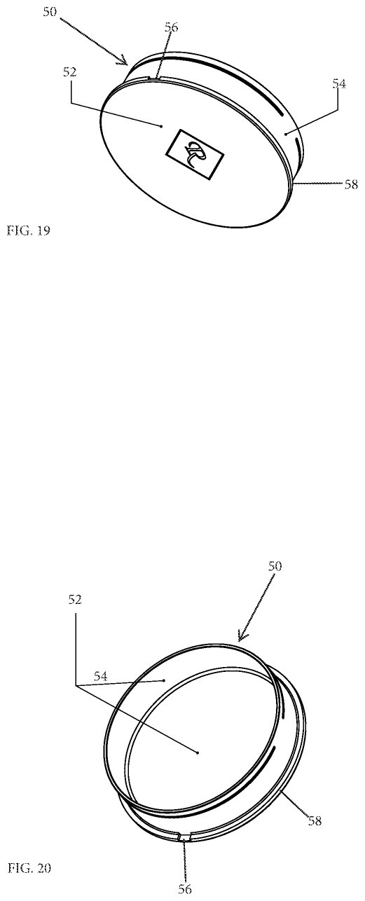

Referring to FIG. 1, labelled as PRIOR ART, there is illustrated a vertical drain 200 behind a wall 300. Vertical drain 200 has a plumbing cleanout fitting 400. Referring to FIG. 2, a cleanout opening 500 is provided through wall 300 in order to provide access to cleanout fitting 400. This is the environment in which a plumbing access cover is used. A plumbing access cover, generally identified by reference numeral 10, will now be described with reference to FIG. 3 through FIG. 16. A spacer ring accessory will be described with reference to FIG. 17 and FIG. 18. A flat cap variation will be described with reference to FIG. 19 and FIG. 20.

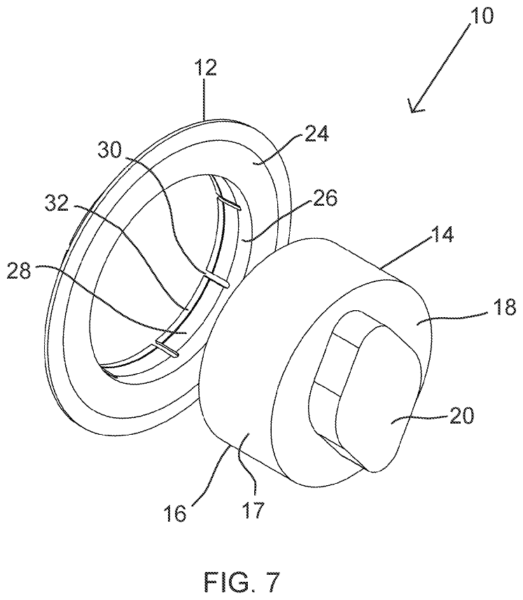

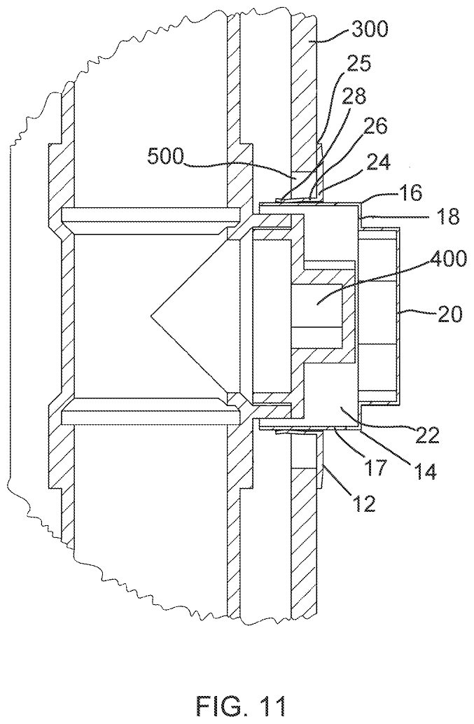

Referring FIG. 7, plumbing access cover 10 includes an escutcheon 12 and a cap 14. Cap 14 has a hollow cap body 16 with a peripheral side wall 17 and an end wall 18. It is preferred, but not essential, that peripheral sidewall 17 be cylindrical. It is preferred, but not essential that a hand grip 20 be provided for use in removing cap 14. Referring to FIG. 11, cap body 16 has a hollow interior 22 defined by peripheral sidewall 17 and end wall 18.

Referring to FIG. 7, escutcheon 12 includes a flange 24 and a retention collar 26. Retention collar 26 must be in a configuration that is compatible with and can accommodate in mating engagement peripheral sidewall 17. In this instance, peripheral sidewall 17 is illustrated as cylindrical and retention collar 26 is also shown as being cylindrical. Retention collar 26 has an engagement for engaging peripheral sidewall 17 of cap body 16. This engagement is intended to releasably secure cap body 16 within retention collar 26. The engagement consists of multiple tabs 28 separated by notches 30. Each tab 28 has a distal portion 32 resiliently biased inwards.

Referring to FIG. 11, in use, flange 24 is positioned against wall 300 at cleanout opening 500 (a hole) in wall 300. Wall 300 will typically be clad in drywall and cleanout opening will be made in the drywall. Flange 24 is positioned on wall 300 so as to permit cap body 16 to be inserted into retention collar 26. When in position cap body 16 overlies plumbing cleanout fitting 400.

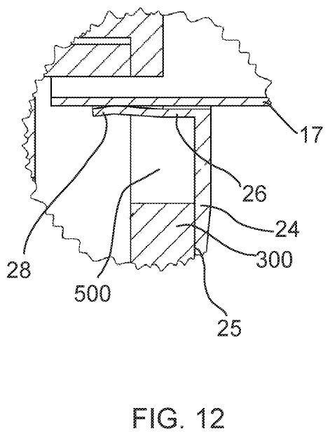

Referring to FIG. 11 and FIG. 12, Flange 24 may be affixed to wall 300 by caulking or with a suitable adhesive, such as, Lepage PL 200™ drywall adhesive. For ease of installation, it is preferred that flange 24 be fitted with peel and stick tape adhesive 25.

Referring to FIG. 11 and FIG. 12, once flange 24 has been affixed to wall 300 by peel and stick tape adhesive 25, cap body 16 is inserted into retention collar 26. This forces tabs 28 to flex outwards whereby the resilient inward biasing of tabs 28 acts to engage peripheral sidewall 17 and releasably secure cap body 16 within retention collar 26. The friction imparted by the resilient inward biasing is sufficient to prevent inadvertent dislodging of cap 14 from escutcheon 12. Hand grip 20 may be used to exert a force to overcome the friction forces exerted by tabs 28 and permit manual removal of cap 14. It is to be noted that there are a range of depths that may be selected for insertion. This is important as the depth of plumbing cleanout fitting may vary.

The strength of the frictional engagement between retention collar 26 and cap body 16 is desirably balanced with the strength of adhesion between flange 24 and wall 300 and the structural integrity of the wall surface. If the frictional engagement is insufficient, cap 14 may be inadvertently dislodged. If the frictional engagement is too great, attempting to remove cap 14 may cause flange 24 to tear away from wall 300.

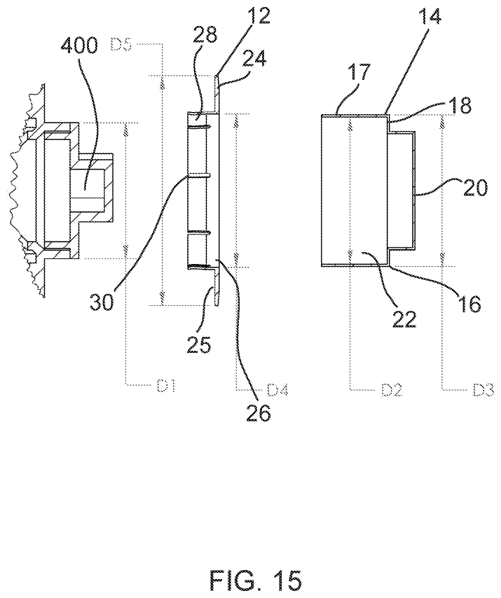

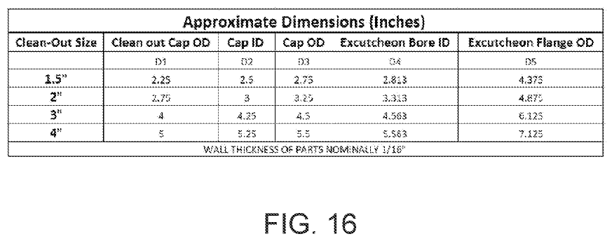

Cap 14 and escutcheon 12 are configured to accommodate different relative sizes and orientations of cleanout fitting 400 and the exterior of the wall cladding. In order to provide a full disclosure FIG. 15 and FIG. 16 provide some exemplary approximate dimensions for escutcheon 12 and cap 14. Cap 14 may be manufactured to different depths/lengths and both cap 14 and escutcheon 12 may be manufactured with different sizes of circumference. The depth of insertion of cap cylindrical body 16 into retention collar 26 varies depending on the location of cleanout fitting 400 relative to the exterior of the wall cladding of wall 300.

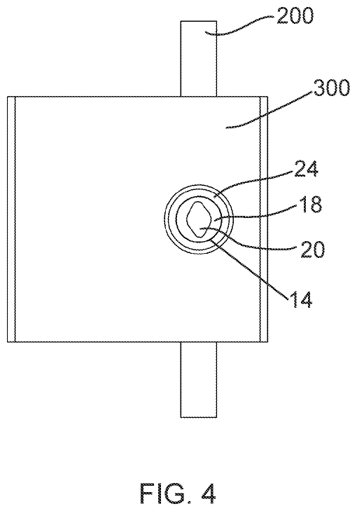

Referring to FIG. 3 and FIG. 4, in some instances, cleanout fitting 400 may be sufficiently distant from the exterior of the wall cladding to permit cap 14 to be inserted far enough to bring the cap end wall 18 into alignment with flange 24. From an appearance perspective, cap 14 is preferably not inserted any further, even though further insertion may be possible.

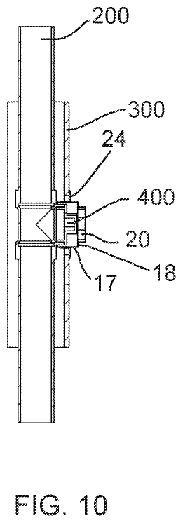

In other instances, such as that shown in FIG. 10 and FIG. 11, cleanout fitting 400 may be too close to the exterior of the wall cladding to permit cap 14 to be inserted far enough to bring cap shoulder 18 into alignment with flange 24, whereby cap 14 will protrude from escutcheon 12 when fully inserted.

Escutcheon 12 and cap 14 may be made from ABS, polycarbonate or other suitable plastics or materials. In most applications, white or black escutcheons 12 and caps 14 will be suitable, but other colours may be used.

Referring to FIG. 17 and FIG. 18, if there is a plumbing cleanout that protrudes beyond the surface of the raised cap, a circular ring, referred to as a “spacer ring” and identified by reference numeral 40 will be used to provide additional height. In such cases escutcheon 12 and cap 14 function as described above, with escutcheon 12 positioned inside spacer ring 40. It will be appreciated that the only function of spacer ring 40 is to provide additional height so that cap 14 will fit over the protruding plumbing cleanout.

Spacer ring 40 is made of the same material as escutcheon 12 and cap 14. Spacer ring 40 has a number of cavities 42 to accommodate an adhesive. Spacer ring 40 will be available in several sizes and depths, such as 2 inch, 2½ inch, 2⅝ inch, 3 inch, 3½ inch, 3⅝ inch, 4 inch, 4½ inch and 4⅝ inch.

Spacer ring 40, is to be placed directly on the wall surface around the opening to the object being covered. Spacer ring will be secured by an adhesive which will hold it in place to the finished wall. There are other methods of securing spacer ring 40 in position, which include but are not limited to: screws, glue, cement, caulking or any other means which will hold spacer ring 40 in place around the protruding plumbing cleanout.

Spacer ring 40 holds escutcheon 12, which is inserted into inside circumference 44 of spacer ring 40. Cap 14 will then fit within escutcheon 12, as previously described.

It is preferred that spacer ring 40 be capable of being trimmed. This facilitates installation flush against a baseboard, where a baseboard might otherwise be in the way and interfere with the installation.

Where there is a protruding plumbing cleanout, it is sometimes preferable to use a flat cap to limit the extent that the installation protrudes into the room. Referring to FIG. 19 and FIG. 20, there is illustrated a cap variation, which has a flat end and is hereinafter referred to as flat cap 50. Flat cap 50 is made of the same materials and has the same details and dimensions as cap 14. Flat cap 50 will have a level uniform top surface 52 (although there may be an indentation for a logo) and a circumferential sidewall 54. Flat cap 50 will have two small notches 56 on the underside of cap flange 58 to allow for a device such as a screwdriver to be inserted to pry on cap flange 58 to facilitate easy removal of flat cap 50. The Tradesman has the choice of using flat cap 50 or cap 14 depending upon the installation, as flat cap 50 and cap 14 are interchangeable.

Although a plumbing cleanout fitting has been chosen for purposes of illustration, it will be understood that plumbing access cover may be used with other plumbing installations where access is required, such as a plumbing shut off valve.

The scope of the claims should not be limited by the preferred embodiments set forth in the examples, but should be given the broadest interpretation consistent with the description as a whole.

What is claimed is:

1. A plumbing access cover, comprising:
a cap having a cap body;
an escutcheon having an annular flange and a retention collar for receiving the cap body; and
an engagement on the retention collar for engaging the cap body, thereby releasably securing the cap body within the retention collar.

2. The plumbing access cover of claim 1, wherein the engagement is a frictional engagement.

3. The plumbing access cover of claim 2, wherein the frictional engagement facilitates securing the cap body within the retention collar at a selected depth of insertion.

4. The plumbing access cover of claim 1, wherein the engagement is comprised of a plurality of tabs with each tab having a distal portion resiliently biased inwards.

5. The plumbing access cover of claim 1, wherein the cap body is cylindrical and the retention collar is cylindrical.

6. The plumbing access cover of claim 1, the escutcheon comprising a peel and stick adhesive about a portion of the annular flange that in use abuts a wall, whereby the annular flange is affixed to a wall by the adhesive.

7. The plumbing access cover of claim 1, wherein a spacer ring is used to space the escutcheon from a wall.
